(19) United States
(12) Patent Application Publication
(10) Pub. No.: US 2025/0253504 A1
(43) Pub. Date: Aug. 7, 2025

(54) JOINING METHOD OF CURRENT COLLECTOR TERMINAL AND CURRENT COLLECTOR TAB

(71) Applicant: TOYOTA JIDOSHA KABUSHIKI KAISHA, Toyota-shi (JP)

(72) Inventor: Tsuyoshi EHARA, Toyota-shi (JP)

(73) Assignee: TOYOTA JIDOSHA KABUSHIKI KAISHA, Toyota-shi (JP)

(21) Appl. No.: 19/014,755

(22) Filed: Jan. 9, 2025

(30) Foreign Application Priority Data
Feb. 7, 2024 (JP) 2024-016882

(51) Int. Cl. H01M 50/536; B23K 26/21

(52) U.S. Cl. CPC H01M 50/536; B23K 26/21

(57) ABSTRACT

A joining method of joining a current collector terminal and a current collector tab, comprising: laminating a current collector terminal, a current collector tab, and a metal protective member in this order; and laser-welding the current collector terminal, the current collector tab, and the metal protective member together by irradiating a laser beam from a side of the metal protective member.

### CROSS-REFERENCE TO RELATED APPLICATION

This application claims priority to Japanese Patent Application No. 2024-016882 filed on Feb. 7, 2024, incorporated herein by reference in its entirety.

### BACKGROUND

### 1. Technical Field

The present disclosure relates to a joining method of joining a current collector terminal and a current collector tab.

### 2. Description of Related Art

A battery generally includes an electrode laminate including a cathode current collector layer, a cathode active material layer, an electrolyte layer, an anode active material layer, and an anode current collector layer. The electrode laminate of the battery is sealed in an internal space surrounded by an outer encasement material such as a laminate film, for example. There is known a battery in which electricity generated in an electrode laminate is led outside by a current collector terminal joined to a current collector tab of the electrode laminate.

### SUMMARY

In the battery using the current collector terminal as described above, when the joining the current collector terminal and the current collector tab by ultrasonic waves is time-consuming. Also, when the current collector terminal and the current collector tab are joined by laser instead of ultrasonic waves, excessive heat may be generated at a portion irradiated by the laser, and the current collector tab may be damaged.

Therefore, an object of the present disclosure is to provide a joining method of a current collector terminal a current collector tab, which can join the current collector terminal and the current collector tab in a short time, and can also suppress damage to the current collector tab.

The present disclosure achieves the above object by the following measures.

### First Aspect

A joining method of joining a current collector terminal and a current collector tab includes
laminating the current collector terminal, the current collector tab, and a metal protective member, in this order, and
performing laser welding of the current collector terminal, the current collector tab, and the metal protective member together, through irradiation by laser from a side of the metal protective member.

### Second Aspect

The joining method according to the First aspect, in which the metal protective member is made of the same material as the current collector tab.

### Third Aspect

A manufacturing method of a battery that includes
fabricating the current collector tab on a side face portion of an electrode laminate,
joining the current collector terminal and the current collector tab by the method according to the First or Second Aspect, and
covering the electrode laminate and the current collector terminal that are joined, by a laminate film, so as to seal the electrode laminate.

According to the joining method of the current collector terminal and the current collector tab according to the present disclosure, the current collector terminal and the current collector tab can be joined in a short time, and also damage to the current collector tab can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram for explaining the joining method of the current collector terminals and the current collector tabs of the present disclosure;

FIG. 1B is a schematic diagram for explaining the joining method joining the current collector terminals and the current collector tabs of the present disclosure;

FIG. 2A is a schematic diagram illustrating a manufacturing method of a battery according to an embodiment of the present disclosure;

FIG. 2B is a schematic diagram illustrating a manufacturing method of a battery according to an embodiment of the present disclosure;

FIG. 2C is a schematic diagram illustrating a manufacturing method of a battery according to an embodiment of the present disclosure;

FIG. 2D is a schematic diagram illustrating a manufacturing method of a battery according to an embodiment of the present disclosure;

FIG. 3A is a schematic diagram for illustrating a manufacturing method of a battery of the present disclosure; and

FIG. 3B is a schematic diagram illustrating a manufacturing method of a battery according to an embodiment of the present disclosure.

### DETAILED DESCRIPTION OF EMBODIMENTS

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Joining Method of Current Collector Terminal and Current Collector Tab

A joining method of joining a current collector terminal and a current collector tab of the present disclosure includes
laminating the current collector terminal, the current collector tab, and a metal protective member, in this order, and
laser welding the current collector terminal, the current collector tab, and the metal protective member together by irradiating a laser beam from the side of the metal protective member.

According to the joining method of the current collector terminal and the current collector tab according to the present disclosure, the current collector terminal and the current collector tab can be joined in a short time, and also damage to the current collector tab can be suppressed.

The inventors of the present disclosure have found that by disposing a metal protective member on a current collector tab, irradiating a laser beam from a side where the metal protective member is disposed, and laser welding the current collector terminal and the current collector tab, it is possible to join the current collector tab in a short time, and it is possible to suppress breakage of the current collector tab. Although not limited to the theory, by disposing the metal protective member and irradiating a laser beam from the side of the metal protective member, the heat generation of the current collector tab is suppressed even in the bonding by the laser. Accordingly, it is presumed that the current collector terminal and the current collector tab can be joined in a short time, and damage to the current collector tab can be suppressed.

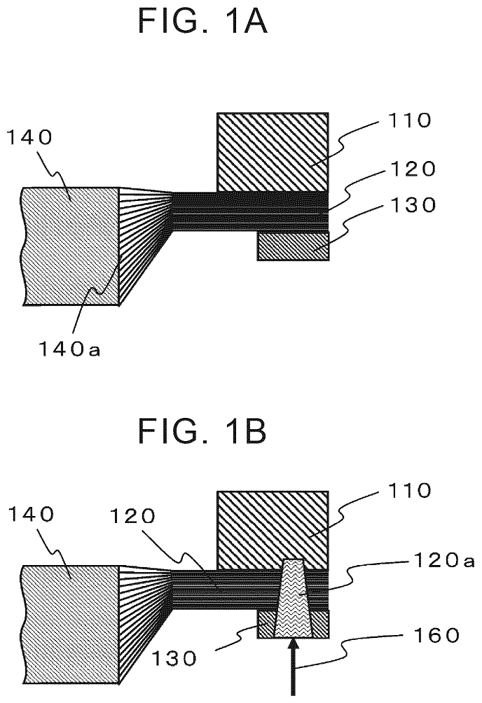

FIGS. 1A and 1B are schematic, but not limited, diagram showing one aspect of the disclosed joining method current collector terminals and current collector tabs.

The electrode laminate 140 includes a current collector tab 120 on a side surface portion 140a of the electrode laminate 140. Joining methods of current collector terminals and current collector tabs, first, as shown in FIG. 1A, the current collector terminal 110, current collector tabs 120, and metal protective member 130 are stacked in this order. Next, as shown in FIG. 1B, the laser 160 is irradiated from the metal protective member 130, and the current collector terminal 110, the current collector tab 120, and the metal protective member 130 are laser-welded together. By irradiating the laser 160, a bonding portion 120a is formed in the current collector terminal 110, the current collector tab 120, and the metal protective member 130, and the current collector terminal 110 and the current collector tab 120 are electrically bonded to each other. By disposing the metal protective member 130 and irradiating the laser 160 from the side of the metal protective member 130, heat generation of the current collector tab 120 is suppressed even in the bonding by the laser. Accordingly, the current collector terminal 110 and the current collector tab 120 can be joined in a short time, and damage to the current collector tab 120 can be suppressed.

### Laser Welding

A method of laser welding is not particularly limited, but a method used for known laser welding may be appropriately employed.

### Current Collector Terminal and Joining Method of Current Collector Tabs; Respective Configurations

Hereinafter, each configuration of the current collector terminal and the current collector tab joining method will be described.

### Current Collector Terminal

The current collector terminal is not particularly limited, but may be made of aluminum, stainless steel (SUS), or the like.

### Current Collector Tab

In the present disclosure, the current collector tab is not particularly limited, but may be connected to a current collector layer of an electrode laminate to be described later. For example, the current collector tab of the cathode may be connected to the cathode current collector layer, and the current collector tab of the anode may be connected to the anode current collector layer.

As a material of the current collector tab, a material that can be used for a battery can be appropriately employed. The material of the current collector tab of the cathode is not particularly limited, but is preferably aluminum. The material of the current collector tab of the anode is not particularly limited, but is preferably copper.

### Metal Protective Member

The metal protective member is not particularly limited, but is preferably made of the same material as the current collector tab. The thickness of the metal protective member is not particularly limited. The thickness of the metal protective member may be 0.1 mm or more, 0.2 mm or more, or 0.5 mm or more from the viewpoint of suppressing heat generation of the current collector tab. The thickness of the metal protective member may be 15 mm or less, 13 mm or less, 9.0 mm or less, 7.0 mm or less, or 5.0 mm or less.

### Battery Manufacturing Method

A manufacturing method of a battery includes the following steps.
Forming a current collector tab on the side face portion of the electrode laminate,
Joining a current collector terminal and a current collector tab in a method of the present disclosure, and
the bonded electrode laminate and the current collector terminal are covered with a laminate film to seal the electrode laminate.

According to the battery manufacturing method of the present disclosure, it is possible to join the current collector terminal and the current collector tab in a short time, and it is possible to suppress breakage of the current collector tab.

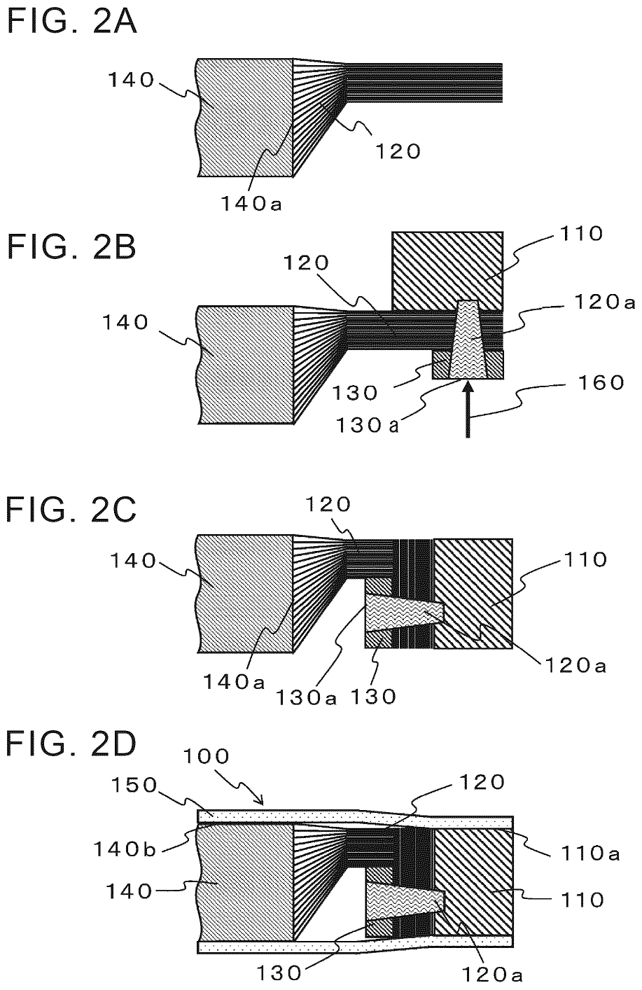

FIGS. 2A to 2D are schematic diagrams illustrating one embodiment of a manufacturing method of a battery according to the present disclosure, and are schematic diagrams illustrating the vicinity of a current collector terminal and a current collector tab. However, the present disclosure is not limited thereto.

As shown in FIG. 2A, in the manufacturing method of the battery the current collector tab 120 is formed on the side face portion 140a of the electrode laminate 140. Next, as shown in FIG. 2B, the current collector terminal 110, the current collector tab 120, and the metal protective member 130 are stacked in this order, and the laser 160 is irradiated from the metal protective member 130. By irradiating the laser 160, a bonding portion 120a is formed in the current collector terminal 110, the current collector tab 120, and the metal protective member 130, and the current collector terminal 110 and the current collector tab 120 are electrically bonded to each other. Next, as shown in FIG. 2C, the current collector tab is bent so that the laser-irradiated surface 130a of the metal protective member 130 and the side surface portion 140a of the electrode laminate 140 face each other. Then, as shown in FIG. 2D, the bonded electrode laminate 140 and the current collector terminal 110 are covered with a laminate film 150. For example, the electrode laminate 140 and the current collector terminal 110 are wound around and covered with the laminate film 150. For example, heat sealing is performed on the heat sealing surface 140b of the electrode laminate in which the electrode laminate 140 and the laminate film 150 are in contact with each other, heat sealing is performed on the heat sealing surface 110a of the current collector terminal in which the current collector terminal 110 and the laminate film 150 are in contact with each other, and the electrode laminate 140 is sealed. The metal protective member 130 is disposed, and the laser 160 is irradiated from the side of the metal protective member 130. Accordingly, heat generation on the current collector tab 120 is suppressed even in the bonding by the laser. Accordingly, the current collector terminal 110 and the current collector tab 120 can be joined in a short time, and damage to the current collector tab 120 can be suppressed.

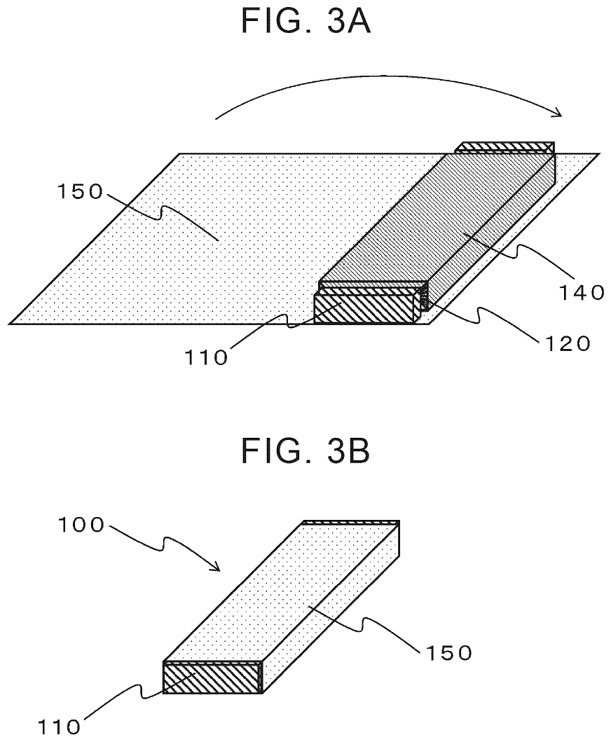

FIGS. 3A and 3B are schematic diagrams illustrating an embodiment of a battery manufacturing method according to an embodiment of the present disclosure, and are schematic diagrams illustrating an overall view of an electrode laminate or a battery, but are not limited thereto.

In FIG. 3A, the bonded electrode laminate 140 and the current collector terminal 110 are disposed on the laminate film 150. As shown in FIG. 3B, the bonded electrode laminate 140 and the current collector terminal 110 are covered with a laminate film 150, for example, wound and covered to seal the electrode laminate 140. Accordingly, the electrode laminate 140 is sealed in a space surrounded by the laminate film 150 and the current collector terminal 110.

### Battery Manufacturing Method; Each Configuration

Hereinafter, each configuration of the battery manufacturing method will be described.

The battery of the present disclosure may be a liquid-based battery containing an electrolyte solution as an electrolyte layer, or may be a solid-state battery having a solid electrolyte layer as an electrolyte layer. In the context of the present disclosure, a “solid battery” means a battery using at least a solid electrolyte as an electrolyte, and therefore a solid battery may use a combination of a solid electrolyte and a liquid electrolyte as an electrolyte. Further, the battery of the present disclosure may be an all-solid-state battery, that is, a battery using only a solid electrolyte as an electrolyte.

In the context of the present disclosure, a “mixture” means a composition capable of forming a cathode active material layer or the like as it is or by further containing other components. In addition, in the context of the present disclosure, the “mixture slurry” means a slurry that includes a dispersion medium in addition to the “mixture” and that can be applied and dried to form a cathode active material layer or the like.

### Electrode Laminate

The electrode laminate is not particularly limited, but may include a cathode current collector layer, a cathode active material layer, an electrolyte layer, an anode active material layer, and an anode current collector layer in this order.

### Cathode Current Collector Layer

A material used for the cathode current collector layer is not particularly limited, but a material generally used as a cathode current collector of a battery can be appropriately adopted. Examples of materials used for the cathode current collector layers include, but are not limited to, Cu, Ni, Cr, Au, Pt, Ag, Al, Fe, Ti, Zn, Co, and stainless-steel. Further, the cathode current collector layer may have some coating layer on the surface thereof for the purpose of adjusting the resistance or the like. The cathode current collector layer may be formed by plating or depositing the metal on a metal foil or a base material.

The shape of the cathode current collector layer is not particularly limited, but may be, for example, a foil shape, a plate shape, or a mesh shape. Among the above, the foil shape is preferred.

The thickness of the cathode current collector layers is not particularly limited, but may be 0.1 μm or more, or 1 μm or more, and may be 1 mm or less, or 100 μm or less.

### Cathode Active Material Layer

The cathode active material layer includes at least a cathode active material, and may further optionally include a solid electrolyte, a conductive auxiliary agent, a binder, and the like. The cathode active material layer may further contain various additives. The content of each of the cathode active material, the solid electrolyte, the conductive auxiliary agent, the binder, and the like in the cathode active material layer may be appropriately determined in accordance with the desired battery performance. For example, the content of the cathode active material may be 40% by mass or more, 50% by mass or more, or 60% by mass or more, or 100% by mass or less, or 90% by mass or less, based on 100% by mass of the entire cathode active material layer (the entire solid content).

### Cathode Active Material

The material of the cathode active material is not particularly limited as long as it can occlude and release lithium ions. Cathode active material may be, for example, lithium cobaltate (LiCoO₂), lithium nickelate (LiNiO₂), lithium manganate (LiMn₂O₄), lithium nickel cobalt manganese oxide (NCM: LiCO_{1/3}Ni_{1/3}Mn_{1/3}O₂), lithium nickel cobalt aluminum oxide (LiNi_{0.8}(CoAl)_{0.2}O₂), a heteroelement-substituted Li—Mn spinel having a composition represented by Li₁₊ₓMn_{2-x-y}M_{y}O₄, (where M is one or more metallic elements selected from Al, Mg, Co, Fe, Ni, and Zn), or the like. However, the cathode active material is not limited thereto.

The cathode active material is not particularly limited, but may have a coating layer. The coating layer is a layer containing a material having lithium ion conductivity, having low reactivity with a cathode active material or a solid electrolyte, and capable of maintaining a form of a coating layer that does not flow even when in contact with an active material or a solid electrolyte. In addition to LiNbO₃, specific examples of the material forming the coating layer include Li₄Ti₅O₁₂ and Li₃PO₄, but is not limited thereto.

The shape of the cathode active material is not particularly limited as long as it has a general shape as the cathode active material of the battery. The cathode active material may be in a particulate form, for example. The cathode active material may be a primary particle or a secondary particle in which a plurality of primary particles is aggregated. The mean particle diameter D₅₀ of the cathode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

### Solid Electrolyte

The material of the solid electrolyte is not particularly limited, and may be, for example, a sulfide solid electrolyte, an oxide solid electrolyte, or a polymer electrolyte.

Examples of sulfide solid electrolyte include, but are not limited to, a sulfide-based amorphous solid electrolyte, a sulfide-based crystalline solid electrolyte, an argyrodite-type solid electrolyte, and the like. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, or the like; or combinations thereof. However, the sulfide solid electrolyte is not limited thereto.

Examples of oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON) and the like, or a combination thereof. However, the oxide solid electrolyte is not limited thereto.

The sulfide solid electrolyte and the oxide solid electrolyte may be glass or crystallized glass (glass ceramics).

Examples of polymer electrolytes include polyethylene oxide (PEO), polypropylene oxide (PPO), copolymers thereof and the like, but are not limited to these.

### Conductive Aid

The conductive aid is not particularly limited. The conductive aid may be, for example, but not limited to, vapor-grown carbon fiber (VGCF), acetylene black (AB), Ketjen black (KB), carbon nanotube (CNT), carbon nanofiber (CNF), and the like. The conductive auxiliary agent may be, for example, particulate or fibrous, and the size thereof is not particularly limited. The conductive auxiliary agent is not particularly limited, but only one kind may be used alone, or two or more kinds may be used in combination.

### Binder

The binder is not particularly limited. The binder may be a material such as, but not limited to, polyvinylidene fluoride (PVdF), butadiene rubber (BR), polytetrafluoroethylene (PTFE), styrene butadiene rubber (SBR), and the like. The binder is not particularly limited, but only one binder may be used alone, or two or more binders may be used in combination.

The shape of the cathode active material layer is not particularly limited, but may be, for example, a sheet-like cathode active material layer having a substantially flat surface. The thickness of the cathode active material layers is not particularly limited, but may be, for example, 0.1 μm or more, 1 μm or more, or 10 μm or more, and may be 2 mm or less, 1 mm or less, or 500 μm or less.

The cathode active material layer can be produced by applying a known method. For example, the cathode active material layer can be easily formed by, for example, dry or wet molding of a cathode mixture containing the above-described various components. The cathode active material layer may be formed together with the cathode current collector layer, or may be formed separately from the cathode current collector layer.

### Electrolyte Layer-Solid Electrolyte Layer

The battery of the present disclosure may have a solid electrolyte layer as a solid battery, i.e., an electrolyte layer. The solid electrolyte layer includes at least a solid electrolyte, and may optionally include a conductive auxiliary agent, a binder, and the like.

For the solid electrolyte, the conductive auxiliary agent, and the binder, reference can be made to the description of “cathode active material layer”.

The thickness of the solid electrolyte layers is not particularly limited, but may be, for example, 0.1 μm or more, 1 μm or more, or 10 μm or more, and may be 2 mm or less, 1 mm or less, or 500 μm or less.

The solid electrolyte layer can be easily formed by, for example, dry or wet molding a solid electrolyte mixture containing the above-described solid electrolyte, binder, and the like.

### Electrolyte Layer-Electrolyte Solution

The battery of the present disclosure may have a liquid-based battery, i.e., an electrolyte retained in an electrolyte, in particular a separator layer, as an electrolyte layer.

### Electrolytic Solution

The electrolyte solution is not particularly limited, but preferably contains a supporting salt and a solvent.

The support salt (lithium salt) of the electrolytic solution having lithium ion conductivity is not particularly limited, and examples thereof include an inorganic lithium salt and an organic lithium salt. Examples of the inorganic lithium salt include, but are not limited to, LiPF₆, LiBF₄, LiClO₄, LiAsF₆. Examples of the organic lithium salt include LiCF₃SO₃, LiN(CF₃SO₂)₂, LiN(C₂F₅SO₂)₂, LiN(FSO₂)₂, LiC(CF₃SO₂)₃ and the like, but are not limited to these cases.

The solvent used in the electrolytic solution is not particularly limited, and examples thereof include cyclic carbonate and chain carbonate. Examples of the cyclic carbonate include, but are not limited to, ethylene carbonate (EC), propylene carbonate (PC), and butylene carbonate (BC). Examples of the linear carbonate include, but are not limited to, dimethyl carbonate (DMC), diethyl carbonate (DEC), ethyl methyl carbonate (EMC), and the like. The electrolytic solution is not particularly limited, but only one kind may be used alone, or two or more kinds may be used in combination.

### Separator

The separator is not particularly limited, but a general separator may be appropriately employed as the separator of the battery. Examples of the separator include polyolefin-based, polyamide-based, and polyimide-based nonwoven fabrics.

### Anode Active Material Layer

The anode active material layer includes at least an anode active material, and may further optionally include a conductive auxiliary agent, a binder, a solid electrolyte, and the like. The anode active material layer may further contain various additives. The content of each of the anode active material, the solid electrolyte, the conductive auxiliary agent, the binder, and the like in the anode active material layer may be appropriately determined in accordance with the desired battery performance. For example, the content of the anode active material may be 40% by mass or more, 50% by mass or more, or 60% by mass or more, and may be 100% by mass or less, or 90% by mass or less, with the total (total solid content) of the anode active material layer being 100% by mass.

### Anode Active Material

As the anode active material, various materials having a potential at which lithium ions are occluded and released (charge and discharge potential) which is a lower potential than that of the cathode active material of the present disclosure can be employed. The material of the anode active material is not particularly limited, and may be metallic lithium or a material capable of occluding and releasing metallic ions such as lithium ions. Examples of the material capable of occluding and releasing metal ions such as lithium ions include, but are not limited to, alloy-based anode active materials, carbon materials, and lithium titanate (Li₄Ti₅O₁₂).

The alloy-based anode active material is not particularly limited, and examples thereof include a Si alloy-based anode active material, a Sn alloy-based anode active material, and the like. The Si alloy-based anode active materials include silicon, silicon oxides, silicon carbides, silicon nitrides, solid solutions thereof, and the like. Si alloy-based anode active material may include a metallic element other than silicon, for example, Fe, Co, Sb, Bi, Pb, Ni, Cu, Zn, Ge, In, Sn, Ti or the like. The Sn alloy-based anode active materials include tin, tin oxide, tin nitride, and solid solutions thereof. Sn alloy-based anode active material may include a metallic element other than tin, for example, Fe, Co, Sb, Bi, Pb, Ni, Cu, Zn, Ge, In, Ti, Si or the like.

The carbon material is not particularly limited, and examples thereof include hard carbon, soft carbon, and graphite.

The shape of the anode active material is not particularly limited, but may be any general shape as the anode active material of the battery. The anode active material may be, for example, in a particulate form or a sheet form.

For the solid electrolyte, the conductive auxiliary agent, and the binder that can be included in the anode active material layer, reference can be made to the above description of “cathode active material layer”.

The shape of the anode active material layer is not particularly limited, but may be, for example, a sheet-like anode active material layer having a substantially flat surface. The thickness of the anode active material layers is not particularly limited, but may be, for example, 0.1 μm or more, 1 μm or more, or 10 μm or more, and may be 2 mm or less, 1 mm or less, or 500 μm or less.

The anode active material layer can be produced by applying a known method. For example, the anode active material layer can be easily formed by, for example, dry or wet molding of the anode mixture containing the above various components. The anode active material layer may be formed together with the anode current collector layer or may be formed separately from the anode current collector layer.

### Anode Current Collector Layer

A material used for the anode current collector layer is not particularly limited, but a material generally used as an anode current collector of a battery can be appropriately adopted. Examples of the material used for the anode current collector layer include, but are not limited to, Cu, Ni, Cr, Au, Pt, Ag, Al, Fe, Ti, Zn, Co, stainless-steel, and carbon sheet. The anode current collector layer may have some coating layer on the surface thereof for the purpose of adjusting resistance or the like.

The shape of the anode current collector layer is not particularly limited, but may be, for example, a foil shape, a plate shape, or a mesh shape. Among them, a foil shape is preferable.

The thickness of the anode current collector layers is not particularly limited, but may be 0.1 μm or more, or 1 μm or more, and may be 1 mm or less, or 100 μm or less.

### Laminate Film

The laminate film has a fusion layer and a metal layer. The laminate film may include, but is not limited to, a fusion layer, a metal layer, and a resin layer in this order.

### Bonding Layer

The material of the fusion layer is not particularly limited, and examples thereof include polyolefin resins and the like. Examples of the polyolefin include, but are not limited to, polypropylene (PP) and polyethylene (PE). The thickness of the fusion layer is not particularly limited, but may be 30 μm or more, 40 μm or more, or 50 μm or more, and may be 110 μm or less, 100 μm or less, or 90 μm or less.

### Metal Layer

Examples of the material of the metal layer include, but are not limited to, aluminum, an aluminum alloy, and stainless steel. The thickness of the metal layer is not particularly limited, but may be 20 μm or more, 30 μm or more, or 40 μm or more, and may be 70 μm or less, 60 μm or less, or 50 μm or less.

### Resin Layer

Examples of the material of the resin layer include, but are not limited to, polyethylene terephthalate and nylon. The thickness of the resin layer is not particularly limited, but may be 70 μm or more, 80 μm or more, or 90 μm or more, and may be 270 μm or less, 250 μm or less, or 230 μm or less.

With regard to the current collector terminal and the current collector tab, reference can be made to the description of “a joining method of the current collector terminal and the current collector tab; each configuration” described above.

### Battery Applications, Etc.

The battery in the present disclosure is not particularly limited, but may be a lithium ion secondary battery. The battery in the present disclosure may be, for example, an in-vehicle battery, or may be used as a power source for a moving object (for example, a railway, a ship, or an aircraft) other than a vehicle, or may be used as a power source for an electric product such as an information processing apparatus.

While embodiments of the current collector terminal and the current collector tab joining method and the battery manufacturing method of the present disclosure have been described, those skilled in the art will appreciate that changes can be made without departing from the scope of the claims.

What is claimed is:

1. A joining method of joining a current collector terminal and a current collector tab, the joining method comprising:
laminating the current collector terminal, the current collector tab, and a metal protective member, in this order; and
performing laser welding of the current collector terminal, the current collector tab, and the metal protective member together, through irradiation by laser from a side of the metal protective member.

2. The joining method according to claim 1, wherein the metal protective member is made of the same material as the current collector tab.

3. A manufacturing method of a battery that includes:
fabricating the current collector tab on a side face portion of an electrode laminate;
joining the current collector terminal and the current collector tab by the method according to claim 1; and
covering the electrode laminate and the current collector terminal that are joined, by a laminate film, so as to seal the electrode laminate.
